(19) United States
(12) Patent Application Publication
(10) Pub. No.: US 2005/0156528 A1
(43) Pub. Date: Jul. 21, 2005

(54) Metal halide lamp and lighting apparatus using the same

(76) Inventors: Hiroshi Nohara, Nishinomiya-shi (JP); Atsushi Utsubo, Toyonaka-shi (JP); Yukiya Kanazawa, Osaka-shi (JP)

Correspondence Address: SNELL & WILMER LLP, 1920 MAIN STREET, SUITE 1200, IRVINE, CA, 92614-7230, US

(21) Appl. No.: 11/009,814

(22) Filed: Dec. 8, 2004

(30) Foreign Application Priority Data
Dec. 12, 2003 (JP) 2003-414488

(51) Int. Cl. H01J 17/20; H01J 17/16; H01J 61/30; H01J 61/12

(52) U.S. Cl. 313/634; 313/493; 313/573; 313/637; 313/638

(57) ABSTRACT

A metal halide lamp that includes an arc tube having an envelope made of translucent ceramic and a pair of electrodes disposed in the envelope, wherein a sodium (Na) halide, a mercury (Hg) halide, and one or more lanthanide halides are enclosed within the arc tube, the lanthanide halides including at least one of a cerium (Ce) halide and a praseodymium (Pr) halide, and L/D≧1, where D (mm) is an inside diameter of the arc tube, and L (mm) is a distance between the electrodes.

This application is based on application NO.2003-414488 filed in Japan, the contents of which are hereby incorporated by reference.

### BACKGROUND OF THE INVENTION

(1) Field of the Invention

The present invention relates to a metal halide lamp and a lighting apparatus using the same.

(2) Description of the Related Art

A metal halide lamp is commonly used for outdoor lighting, high ceiling lighting, and soon. In recent years, a metal halide lamp using translucent ceramic as a material for the envelope of the arc tube has been developed actively. (This type of metal halide lamp is hereinafter called “a ceramic metal halide lamp”.)

The arc tube having the envelope made of translucent ceramic has lower chemical reactivity with a halide enclosed within the arc tube than an arc tube having an envelope made of silica glass. This means that the arc tube having the envelope made of translucent ceramic is capable of raising the bulb wall loading. Therefore, the arc tube having the envelope made of translucent ceramic has an advantage that it can realize high luminous efficiency.

In particular, it is supposed that a ceramic metal halide lamp having a long and thin arc tube (satisfying L/D>5 when inside diameter of the arc tube is D and the distance between electrodes is L) within which cerium iodide (CeI₃) and sodium iodide (NaI) are enclosed realizes extremely high luminous efficiency as high as 111-177 LPW (=lm/W) (e.g. published Japanese translations of PCT international publication for patent applications No.2000-501563).

In addition, this halide lamp requires less amount of metallic mercury because of its long and thin shape, and therefore it is ecologically friendly as well. For instance, when the rated lamp wattage of the lamp is 150 W, only 0.7 mg (<1.6 mg/cm³) is required to gain 80V-100V of lamp voltage.

However, by manufacturing such a ceramic metal halide lamp by way of trial, the inventors of the present invention proved that although the halide lamp realizes relatively high luminous efficiency, its lamp voltage rises during the lighting, and the light goes off unexpectedly (lighting failure) because the discharge can not be sustained. Such a problem occurred even when a rectangular wave voltage was applied to the lamp with use of an electronic ballast as well as when a sine wave voltage at commercial frequency was applied.

As a result of an examination, the inventors found that the cause of this problem is as follows. The shape of the arc tube becomes long and thin when L/D is large, and the temperature inside the arc tube becomes extremely high because of the short distance from the internal surface of the arc tube and the arc. As a result, even ceramic is chemically combined with the halide gradually, and the amount of a luminescent metal contributing to the discharge decreases. Accordingly, the amount of the free halogen increases, which makes the vapor pressure in the arc tube extremely high. This raises the lamp voltage markedly.

Also, the inventors found that when the inventors lit up the above-described ceramic metal halide lamp with use of a common magnetic ballast for performing dimming control, the lamp voltage unexpectedly changed according to the change of the input voltage. In this case, the ceramic and the halide reacted together strongly, the lamp voltage rose, and the lighting failure occurred.

By the way, when a common mercury doser is used for enclosing mercury as a liquid metal within the arc tube, a piece-to-piece variation in the amount of the enclosed mercury might occur, because of the liquidity of mercury. If large amount of mercury is enclosed in each product, the individual difference becomes relatively small. However, the ceramic metal halide lamp uses a very small amount of mercury. In a sense, this is an advantage of the ceramic metal halide lamp. On the other hand, the individual difference occurring in the manufacturing process might become a considerable amount compared to the designed amount. This causes another problem that the lamp voltage varies for each product because of the individual difference.

### SUMMARY OF THE INVENTION

The object of the present invention is therefore to provide a metal halide lamp that realizes high luminous efficiency with suppressed rise in a lamp voltage during lighting and has less piece-to-piece variation in a lamp voltage, and a lighting apparatus using the same.

The above object is fulfilled by a metal halide lamp, comprising an arc tube having an envelope made of translucent ceramic and a pair of electrodes disposed in the envelope, wherein a sodium (Na) halide, a mercury (Hg) halide, and one or more lanthanide halides are enclosed within the arc tube, the lanthanide halides including at least one of a cerium (Ce) halide and a praseodymium (Pr) halide, and L/D≧1, where D (mm) is an inside diameter of the arc tube, and L (mm) is a distance between the electrodes.

Note that “the inside diameter of the arc tube D” in this Specification is derived in the following way. Firstly, calculate the area of a portion of the internal surface of the arc tube, which surrounds a portion of the axis of the arc tube. This portion of the axis indicates the distance L between the electrodes. Secondly, divide the calculated internal area by the distance L.

As a matter of course, when the internal structure of the arc tube is more complicated, more complicated method for an equation might be required to derive the inside diameter of the arc tube D.

With the stated structure, the metal halide lamp can realize high luminous efficiency, and prevent a lighting failure during the lighting caused by rise in a lamp voltage. Also, the lamp can reduce a piece-to-piece variation in the lamp voltage.

Here, 0.05≦H_{hg}/Hₗₙ≦2.00 may be satisfied, where H_{hg} (mol) is an amount of a halogen included in the mercury halide, and Hₗₙ (mol) is an amount of a halogen included in the lanthanide halides.

With the stated structure, the lamp can surely prevent the lighting failure during the lighting caused by rise in the lamp voltage, and prevent a breakage of the electrodes as well.

Here, the mercury halide may be a mercurous halide.

With the stated structure, the amount of the enclosed mercury can be reduced more.

Here, 4≦L/D≦10 may be satisfied.

With the stated structure, the lamp can realize extremely high luminous efficiency, further suppress the rise in the lamp voltage, and prevent a blackening on an internal surface of the arc tube, which ruins the appearance.

Here, a bulb wall loading may be in a range of 28 W/cm² to 33 W/cm².

With the stated structure, the lamp can realize all of a high luminous efficiency, a long life of the lamp, and a high color rendering.

Here, the metal halide lamp further comprises a bulb made of hard glass surrounding the arc tube, wherein a pressure in a space between the bulb and the arc tube is equal to or less than 5×10⁴ Pa at 300K.

With the stated structure, the lamp can prevent the decreasing of the luminous efficiency.

Meanwhile, the above object is fulfilled by a lighting apparatus, comprising: the stated metal halide lamp; and an electronic ballast operable to light the metal halide lamp.

With the stated structure, the lighting apparatus can realize high luminous efficiency, and prevent the lighting failure during the lighting caused by rise in the lamp voltage. Also, the lighting apparatus can reduce the piece-to-piece variation in lamp voltage.

Here, the lighting apparatus may comprise: the stated metal halide lamp, and an electronic ballast operable to perform a dimming control of the metal halide lamp in a range from 25% to 100% of a rated lamp wattage.

With the stated structure, the lighting apparatus can realize high luminous efficiency, and prevent the lighting failure during the lighting caused by the rise in the lamp voltage. Also, the lighting apparatus can reduce the piece-to-piece variation in the lamp voltage. Further, the lighting apparatus can suppress a fluctuation of the lamp voltage caused by a change of an input lamp voltage at a time of dimming control, and suppress a change of a color temperature.

Here, 0.004<H_{hg}/Hₜ<0.220 may be satisfied, where H_{hg} (mol) is an amount of a halogen included in the mercury halide, and Hₜ (mol) is a total amount of metal included in all the metal halides enclosed within the arc tube except the mercury halide.

With the stated structure, the lighting apparatus can surely reduce the fluctuation of the lamp voltage and the change of the color temperature at the time of the dimming control.

Here, the metal halide lamp may be lit with use of a rectangular-wave current.

With the stated structure, the lighting apparatus can suppress a fluctuation of the lamp voltage caused by a change of an input lamp voltage, and stabilize the temperature of the arc tube, and realize evenness of its temperature distribution. As a result, the lighting apparatus can stabilize the vapor pressure of the enclosure in the arc tube, and suppress the raise in the lamp voltage.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a front elevational view of a metal halide lamp pertaining to the first embodiment of the present invention;

FIG. 2 is a front sectional view of an arc tube used in the metal halide lamp;

FIG. 3 represents a relation between L/D and luminous efficiency;

FIG. 4 represents a result of a life test where a total amount of enclosure and H_{hg}/Hₗₙ are changed;

FIG. 5 is a block diagram of a lighting apparatus pertaining to the third embodiment of the present invention;

FIG. 6 is a circuit diagram of an electronic ballast used in the lighting apparatus;

FIG. 7 is a schematic view of a modification of an arc tube used in the metal halide lamp of each embodiment of the present invention;

FIG. 8 is a schematic view of a modification of an arc tube used in the metal halide lamp of each embodiment of the present invention;

FIG. 9 is a schematic view of a modification of an arc tube used in the metal halide lamp of each embodiment of the present invention;

FIG. 10 is a schematic view of a modification of an arc tube used in the metal halide lamp of each embodiment of the present invention;

FIG. 11 is a schematic view of a modification of an arc tube used in the metal halide lamp of each embodiment of the present invention; and

FIG. 12 is a schematic view of a modification of an arc tube used in the metal halide lamp of each embodiment of the present invention.

### DESCRIPTION OF THE PREFERRED EMBODIMENTS

The following describes preferred embodiments of the present invention with reference to the figures.

### The First Embodiment

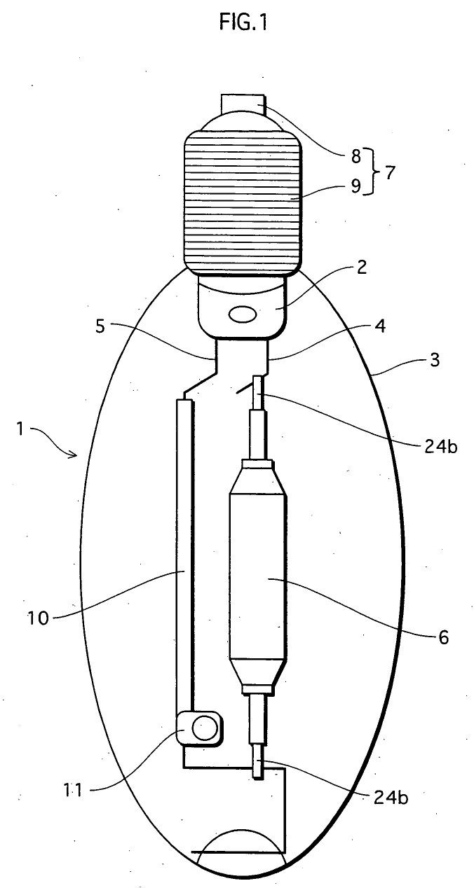

As FIG. 1 shows, a metal halide lamp (a ceramic metal halide lamp) 1 of the, first embodiment of the present invention with the rated lamp wattage of 150 W includes a bulb 3, feeders 4 and 5, an arc tube 6, and a base 7. The bulb 3 is made of hard glass or borosilicate glass or the like. One end of the bulb is blocked and the other end is sealed with a flare 2 made of borosilicate glass. The feeders 4 and 5 are made of nickel or mild steel, for instance. A portion of each of feeders 4 and 5 is sealed to the flare 2. Also, one end of each of feeders 4 and 5 is drawn into the bulb 3. The arc tube 6 is supported by these feeders 4 and 5 in the bulb 3. The base 7 is of a screw type (E type) and fixed to the other end of the bulb 3.

Note that the space in the bulb 3 is a vacuum having approximately 1×10⁻¹Pa at a temperature of 300K.

The other end of the feeder 4 is electrically connected to an eyelet 8 of the base 7, and the other end of the feeder 5 is electrically connected to a shell 9 of the base 7. A portion of the feeder 5 drawn into the bulb 3 is covered by a tube 10, which is for preventing photoelectrons from being generated on the surface of the feeder 5. Further, a getter 11 is attached to the feeder 5 in order to absorb an impure gas in the bulb 3.

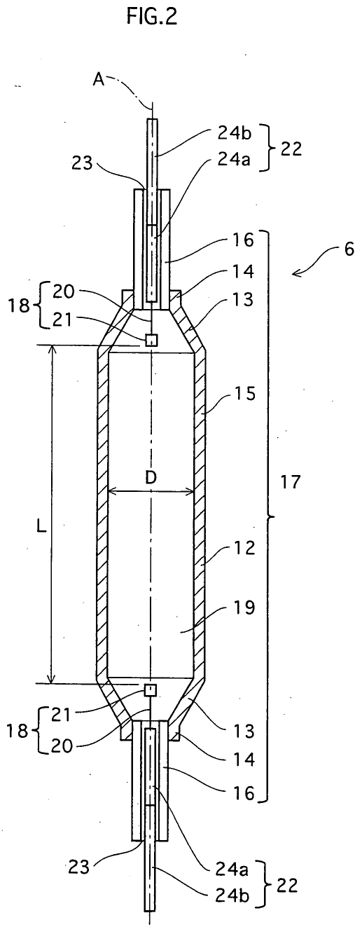

As FIG. 2 shows, the arc tube 6 includes an envelope 17 made of polycrystalline alumina, including a main tube 15 and thin tubes 16. The main tube 15 includes a cylinder 12, tapers 13, and rings 14. The inside diameter D of the cylinder 12 is 4 mm. The tapers 13 are connected to both ends of the cylinder 12. The ring 14 is formed on one end of each taper 13. This end is not the end connected to the cylinder 12. The thin tubes 16 are shrinkage-fit to the rings 14 respectively.

In the example shown in FIG. 2, the cylinder 12, the tapers 13, and the rings 14 are integrally and seamlessly formed. As a matter of course, these members 12, 13, and 14 may be integrally formed by shrinkage-fitting.

Also, the envelope 17 may be made of translucent ceramics other than polycrystalline alumina, such as yttrium aluminum garnet (YAG), aluminum nitride, yttria, and zirconia.

Within the arc tube 6, in total, 10 mg of praseodymium iodide, sodium iodide, and mercuric iodide are enclosed, and xenon (Xe) is enclosed so as to have 20 kPa at a room temperature. In particular, the amount of the mercuric iodide is 0.7 mg, which includes 0.3 mg of mercury. When a mercuric halide includes H_{hg} (mol) of halogen, and the praseodymium includes Hₗₙ (mol) of halogen, H_{hg}/Hₗₙ is 1.00.

The capacity of the arc tube 6 is 0.45 cc in a state where electrodes 18 are inserted in the thin tubes 16. The electrodes 18 are described later.

In the main tube 15, a pair of electrodes 18 is disposed so as to have substantially the same axis (an axis A in FIG. 2) and substantially opposite to each other. A discharge space 19 is formed within the main tube 15. The distance L between each electrode 18 is 32 mm. L/D is 8.

Each electrode 18 includes an electrode rod 20 made of tungsten having 0.5 mm in diameter, and an electrode coil 21 made of tungsten disposed on the tip of the electrode rod 20.

An electrode inductor 22 is inserted into the thin tube 16. One end of the electrode inductor 22 is electrically connected to the electrode 18. The other end of the electrode inductor 22, where there is a gap formed between the internal surface of the thin tube 16 and a second member 24b included in the electrode inductor 22, is sealed with an in poured glass frit 23. The second member 24b is described later.

The electrode conductor 22 includes a first member 24a and a second member 23b. The first member 24a is made of molybdenum or conductive cermet, for instance. The electrode rod 20 is connected to the first member 24a. The second member 24b is made of niobium, for instance. Either of the members 24a and 24b has 0.9 mm in diameter. One end of the second member 24b, which is not the end adjoining to the first member 24a, is lead out of the thin tube 16. The second member 24b is connected to feeders 4 and 5.

As to such a metal halide lamp 1 pertaining to the first embodiment of the present invention having the rated lamp wattage of 150W (hereinafter called “the practical example 1”), the inventors had a life test. In this test, the inventors lit up the practical example 1 with alternating current having rectangular wave at frequency 150 Hz with use of a publicly known electronic ballast. This is repeated in a predetermined ON/OFF cycle.

The number of samples is five.

For comparison, the inventors also had the same life test as to another metal halide lamp (comparative example 1) that has the same structure as the practical example 1 except that metallic mercury in a liquid form is enclosed within the arc tube 6 instead of mercuric iodide. In this test, again, the inventors lit up the comparative example 1 with alternating current having rectangular wave at frequency 150 Hz with use of the same publicly known electronic ballast. This also is repeated in the predetermined ON/OFF cycle.

The life test revealed that the lamp voltage rarely rose with all the samples of the practical example 1 until 1000 hours passed from the start of the lighting. Further, when 12000 hours, which is the rated lifetime, passed from the start of the lighting, the lamp voltage had risen by not more than 20V. This is not a problem in actual use.

To the contrary, in the samples of the comparative example 1, the lamp voltage had risen by not less than 30V when 500 to 1000 hours passed from the start of the lighting. Further, the re-striking potential at the start of lighting became markedly high, and two out of five samples could not be lit up. Examining these two samples, the inventors found that there is a trace of strong chemical reaction with metal iodide on the internal surface of the main tube 15 in the vicinity of the electrode 18.

The inventors conclude that the reason why the arc discharge could not be sustained is as follows.

The trace of strong chemical reaction with metal iodide, and the high re-striking potential at the start of lighting suggest that the vapor pressure of iodine in the arc tube 6 was abnormally high during the lighting. This excess iodine is supposed to be a product of the above-described chemical reaction. To the contrary, in the practical example 1, the extreme increase of excess free iodine is suppressed, and therefore the vapor pressure of iodine in the arc tube is prevented from becoming abnormally high as the comparative example 1. This is because excess iodine is previously enclosed within the arc tube 6 with intention. The equilibrium state of the above-described chemical reaction is kept and the iodine is not produced from the early stage of the lighting.

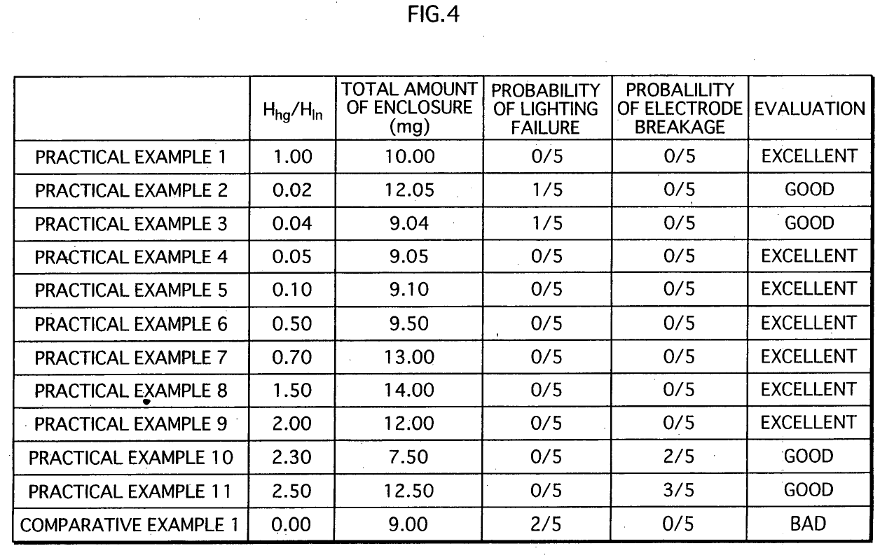

Next, the inventors manufactured metal halide lamps (practical examples 2 to 11), each having the rated lamp wattage of 150 W and the same structure as the practical example 1 except that the total amount of the enclosed praseodymium iodide, sodium iodide, and mercuric iodide and the ratio H_{hg}/Hₗₙ vary from each other as shown in FIG. 4, which is described later. Then, the inventors measured the lamp voltages during the early stage of the lighting (for 100 hours from the start of the lighting) as to the practical examples 2 to 11 adding to the practical example 1 and the comparative example 1. The following is the result.

As to all the practical examples 1 to 11 having mercury halides enclosed therein, the lamp voltages are in a range from 80V to 100V. This is because the mercury halide is in solid form and easy to handle with, and therefore the amount of the halide can be controlled accurately and stability of the amount of the halide enclosed in each lamp can be realized.

Surprisingly, the practical examples require 0.7 mg of mercuric halide including only 0.3 mg of mercury to gain lamp voltage in a range from 80V to 100V. This amount is less than a half of the amount of the mercury in a liquid form enclosed within the comparative example 1 (requiring 0.7 mg of mercury to gain the same lamp voltage).

In contrast, the comparative example 1, within which mercury as a liquid metal-is enclosed, has a piece-to-piece variation in the lamp voltage, which is in the range from 60V to 115V. This is because the amount (the designed amount) of the enclosed mercury as a liquid metal is as small as 0.7 mg. Even if the mercury douser has only a small piece-to-piece variation in the amount of the enclosure, the small amount (0.7 mg) makes the variation relatively, large. As a result, the amount of the enclosure varies greatly for each lamp.

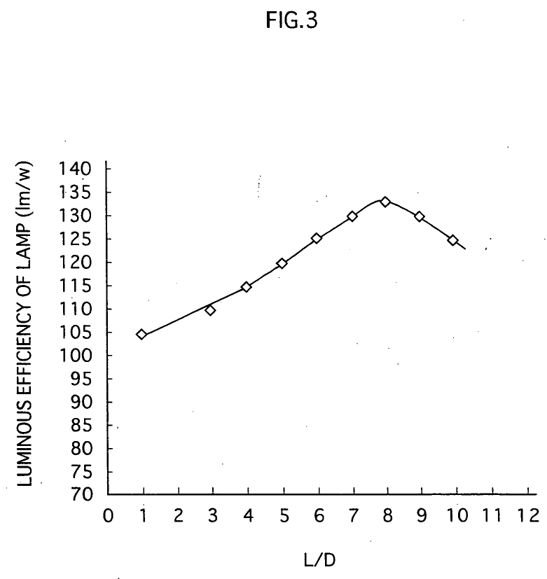

Next, the inventors manufactured metal halide lamps, each having the rated lamp wattage of 150 W and the same structure as the practical example 1 except that L/D is varied from each other while the capacity of the arc tube is fixed (0.45 cc). L/D is the ratio of the distance L between the electrodes 18 to the inside diameter D, the values of L/D are numbered from 1 to 20 respectively. FIG. 3 shows the luminous efficiencies (lm/W) of the manufactured lamps.

Commercially available metal halide lamp with high luminous efficiency and high color rendering, having the rated lamp wattage of 150 W, generally has 90 lm/W to 95 lm/W of luminous efficiency. It is generally said that human beings can visually recognize an increase of luminance when luminous flux (lm) is increased by not less than 10%.

As FIG. 3 shows, the luminous efficiency becomes more than 105 lm/W when L/D≧1 is satisfied. This increased luminous efficiency over the conventional metal halide lamp can be visually recognized by a man as an increase of the brightness.

AS FIG. 3 also shows, the luminous efficiency becomes more than 115 lm/W when L/D≧4 is satisfied. This increased luminous efficiency can be visually recognized as increase of the brightness more clearly. Further, the rise in the lamp voltage is only 18V when 12000 hours passed from the start of the lighting. Therefore, it is preferable that a relational expression L/D≧4 is satisfied in order to increase the luminous efficiency over the conventional metal halide lamp to an extent where the luminous efficiency can be visually recognized as an increase of the brightness very clearly, and suppress the rise in the lamp voltage.

However, when L/D>10 was satisfied, remarkable blackening was observed on the internal surface of the arc tube 6. This blackening lowers the luminous flux, and it is undesirable in a view of the appearance as well.

This blackening is caused by tungsten, which is the material of the electrodes, being diffused and attaching to the internal surface of the arc tube 6. A possible reason why the tungsten diffused is that the value of L/D becomes too large to realize smooth transition to the arc discharge and the sputtering occurred. The tungsten is diffused by this sputtering.

Therefore, it is preferable that L/D≦10 is satisfied in order to gain high luminous efficiency and not to ruin the appearance.

Further, as FIG. 3 also shows, the luminous efficiency becomes more than 130 lm/W when 7≦L/D≦9 is satisfied, and the rise in the lamp voltage is only 13V when 12000 hours passed from the start of the lighting. Therefore, it is preferable that 7≦L/D≦9 is satisfied in order to gain higher luminous efficiency and suppress the rise in the lamp voltage even more.

When L/D<1 is satisfied, and especially when the lamp is horizontally disposed and lit up, the arc is curved upward by the ascending force within the arc tube 6, and comes close to the internal surface of the arc tube 6. This makes the temperature of the upper internal surface of the arc tube 6 extremely high, and accordingly polycrystalline alumina, which is the material of the envelope 17 of the arc tube 6, and the halide chemically and strongly react together. As a result, the arc shrinks because of free iodine and soon generated by the above-described chemical reaction, and the arc comes closer to the upper internal surface of the arc tube 6. This accelerates the chemical reaction, shrinks the arc more, increases free iodine, and causes the rise in the lamp voltage, and eventually the light goes off. Also, the temperature of the upper internal surface of the arc tube 6 becomes extremely high as described above, and therefore the difference between temperatures of this part and another part of the arc tube becomes great. The polycrystalline alumina might be distorted by this temperature difference. This distortion can be a cause of a crack.

However, when L/D≧1 is satisfied, the curving of the arc is suppressed and the lighting failure is prevented. Also, the crack is prevented.

When L/D>20 is satisfied, which is not shown in the FIG. 3, the luminous efficiency becomes equal to or less than 95 lm/W. This is almost the same level as the conventional metal halide lamp. In this case, the starting voltage becomes high. Therefore, it is preferable for practical use that L/D≦20 is satisfied.

Further, it is preferable that the bulb wall loading (the rated lamp wattage per unit area on the internal surface of the arc tube) is set in a range from 20 W/cm² to 35 W/cm² in order to realize both high luminous efficiency and high color rendering, and suppress the chemical reaction between the halide and the glass frit 23. When the bulb wall loading is less than 20 W/cm², high luminous efficiency and high color rendering might not be realized at the same time. Meanwhile, when the bulb wall loading is more than 35 W/cm², the halide and the glass frit 23 react chemically together and might cause a leak. For realizing high luminous efficiency, long life of the lamp, and high color rendering, it is particularly appropriate when the bulb wall loading is set in a range from 28 W/cm² to 33 W/cm².

As described above, according to the structure of the metal halide lamp 1 pertaining to the first embodiment of the present invention, a relational expression L/D≧1 is satisfied for realizing high luminous efficiency. For instance, when L/D=8, namely when the arc tube 6 is long and thin, and in a case where the temperature of the arc tube increases to an extremely high degree during the lighting because the arc gets close to the internal surface of the arc tube 6, the vapor pressure of iodine in the arc tube 6 is prevented from becoming extremely high. This is because excess iodine is previously enclosed within the arc tube 6, which keeps the equilibrium state of the chemical reaction between polycrystalline alumina and metal iodide, and therefore the iodine is not produced. As a result, the lamp voltage is prevented from rising up and causing lighting failure. Also, mercury as a halide in a solid state is enclosed. This improves the accuracy of the amount of the enclosure during the manufacturing process, and decreases the piece-to-piece variation in the lamp voltage. Further, the lamp requires 0.7 mg of a mercury halide, such as a mercuric halide including only 0.3 mg of mercury, to gain lamp voltage within an appropriate range (80V-100V). This amount of the mercury is less than a half of the case where metal mercury in a liquid form is enclosed, in which 0.7 mg of mercury is required to gain the same lamp voltage. This means that the lamp is capable of decreasing the amount of the mercury as the enclosure, and reducing an environmental burden.

Also, the lamp realizes much higher luminous efficiency than the conventional metal halide lamp (with 90 lm/W-95 lm/W), because a relational expression 4≦L/D≦10 is satisfied in particular. At the same time, the lamp further suppresses the rise in the lamp voltage, and prevents the blackening occurring on the internal surface of the arc tube, which ruins the appearance.

Here, when mercurous iodide is enclosed as a mercury halide instead of mercuric iodide, 0.4 mg of mercurous iodide including only 0.2 mg of mercury is required to gain lamp voltage in a range from 80V to 100V, which means that the amount of mercury as the enclosure is further reduced. Therefore, for reducing the amount of mercury as the enclosure, it is preferable that mercurous iodide is enclosed as a mercury halide.

Also, by examining the optimal amount of the enclosed mercury, the inventors found it preferable that a relational expression 0.05≦H_{hg}/Hₗₙ≦2.00 is satisfied, where H_{hg} (mol) is the amount of halogen included in a mercury halide, such as mercuric iodide, and Hₗₙ (mol) is the amount of halogen included in a lanthanide halide, such as praseodymium iodide. The following is the ground of this relational expression.

Firstly, the inventors manufactured the metal halide lamps (the practical examples 2 to 11), each having the rated lamp wattage of 150 W and the same structure as the practical example 1 except that the total amount of the enclosed praseodymium iodide, sodium iodide, and mercuric iodide and the ratio H_{hg}/Hₗₙ vary from each other as shown in FIG. 4. Then, the inventors had a life test. In this test, the inventors lit up the practical examples 2 to 11 adding to the practical example 1 and the comparative example 1, with alternating current having rectangular wave at frequency 150 Hz with use of a publicly known electronic ballast. This is repeated in a predetermined ON/OFF cycle. Then, the inventors measured the probability of the lighting failure caused by the rise in the lamp voltage and the probability of the breakage of the electrodes 18 until 12000 hours passed from the start of the lighting. FIG. 4 shows the result.

Note that the practical examples and the comparative examples have five samples for each. In FIG. 4, the denominators in “probability of lighting failure” and “probability of breakage of electrodes” represent the number of samples, and the numerators represent the number of samples in which the lighting failure or the breakage of the electrodes is observed.

As FIG. 4 shows, when a relational expression 0.05≦H_{hg}/Hₗₙ≦2.00 was satisfied, no lighting failure caused by the rise in the lamp voltage and the breakage of the electrodes 18 occurred in the practical examples 1 and 4 to 9.

Meanwhile, when H_{hg}/Hₗₙ<0.05 was satisfied, the lighting failure caused by the rise in the lamp voltage occurred in one example out of five for each of the practical examples 2 and 3, for instance. This is because the amount of previously enclosed iodine was not sufficient. On the other hand, when H_{hg}/Hₗₙ>2.00 was satisfied, although the rise in the lamp voltage did not cause the lighting failure, the appropriate lamp voltage (80V to 100V) could not be sustained and the light went off in the early stage of the lighting in the practical examples 10 and 11, for instance. At the same time, the breakage of the electrodes 18 occurred during the life test in some samples of these examples. This is because the amount of iodine enclosed within the arc tube 6 became too excessive, and the electrode rod 20 was eroded by the excess iodine as time advanced, which resulted in the breakage of the electrodes.

As described above, it is preferable that the relational expression 0.05≦H_{hg}/Hₗₙ≦2.00 is satisfied for surely preventing the lighting failure caused by the raise in lamp voltage, and preventing the breakage of the electrodes 18.

Note that the inventors confirmed that this relational expression is applicable not only to the case where the mercuric iodide is used, but also to the case where a mercury halide, such as mercuric bromide and mercurous iodide. Also, it is applicable not only to the case where the praseodymium iodide is used, but also to the case where a lanthanide halide, such as praseodymium bromide and later-described cerium iodide.

Also the inventors found that when the bulb 3 of the above-described metal halide lamp 1 is made of hard glass, it is preferable that the pressure in the space between the bulb 3 and the arc tube 6 is not more than 5×10⁴ Pa at 300K for preventing the decrease of the luminous efficiency. When the pressure is more than 5×10⁴ Pa at 300K, the luminous efficiency decreases not less than 5 lm/W from the practical example 1 (1×10³ Pa at 300K) for instance. This is because the heat of the arc tube 6 conducts to the bulb 3 via the gas in the space, and the heat is emitted to the outer space. It is much preferable that the pressure is not more than 1×10³ Pa at 300K.

### The Second Embodiment

A metal halide lamp of the second embodiment of the present invention having the rated lamp wattage of 150 W has the same structure as the halide lamp 1 of the first embodiment of the present invention having the rated lamp wattage of 150 W except that cerium iodide is enclosed within the arc tube instead of praseodymium iodide.

The total amount of cerium iodide, sodium iodide, and mercuric iodide is 10 mg, and the mole ratio among these enclosures is 1:10.5:0.72. Note that the “mole ratio” mentioned here means the mole ratio of only metals included in a metal halide.

When the amount of halogen included in mercuric iodide is H_{hg} (mol) and the amount of halogen included in cerium iodide is Hₗₙ (mol), H_{hg}/Hₗₙ is 0.72.

With the above-described structure of the metal halide lamp pertaining to the second embodiment of the present invention, when L/D≦1 is satisfied (e.g. L/D=8. In this case, the arc tube 6 is long and thin) and when the temperature of the arc tube 6 becomes extremely high during the lighting because of the short distance from the internal surface of the arc tube and the arc, the vapor pressure in the arc tube 6 is prevented from becoming abnormally high just as the metal halide lamp pertaining to the first embodiment of the present invention. This is because excess iodine is previously enclosed, which suppress the chemical reaction between metal iodide and polycrystalline alumina constituting the envelope 17 of the arc tube 6. As a result, the lighting failure caused by the rise in the lamp voltage can be prevented. Also, mercury as a halide in a solid state is enclosed, and this improves the accuracy of the amount of the enclosure during the manufacturing process, and decreases the piece-to-piece variation in the lamp voltage. Further, the lamp is capable of decreasing the amount of the mercury as the enclosure, and reducing an environmental burden.

The lamp realizes much higher luminous efficiency than that of the conventional metal halide lamp (90 lm/W-95 lm/W), because a relational expression 4≦L/D≦10 is satisfied in particular. At the same time, the lamp further suppresses the rise in the lamp voltage, and prevents the blackening occurring on the internal surface of the arc tube, which ruins the appearance.

Also, for reducing the amount of mercury as the enclosure, it is preferable that mercurous iodide as a mercury halide is enclosed.

Also, it is preferable that a relational expression 0.05≦H_{hg}/Hₗₙ≦2.00 is satisfied for preventing the lighting failure caused by the raise in lamp voltage and preventing the breakage of the electrodes 18.

Also, it is preferable that the bulb wall loading is set in a range from 20 W/cm² to 35 W/cm² in order to realize both high luminous efficiency and high color rendering, and suppress the chemical reaction between the halide and the glass frit 23. For realizing high luminous efficiency, long life of the lamp, and high color rendering, it is particularly appropriate when the bulb wall loading is set in a range from 28 W/cm² to 33 W/cm² Further, it is preferable that the pressure in the space between the bulb 3 and the arc tube 6 is not more than 5×10⁴ Pa at 300K for preventing the decrease of the luminous efficiency. In particular, it is preferable that the pressure is not more than 1×10³ Pa at 300K.

### The Third Embodiment

As FIG. 5 shows, a lighting apparatus pertaining to the third embodiment of the present invention includes the metal halide lamp 1 (practical example 1) pertaining to the first embodiment of the present invention and an electronic ballast 25. The metal halide lamp 1 has the rated lamp wattage of 150 W. The electronic ballast 25 can change the input lamp wattage in a range from 25% to 100% of the rated lamp wattage.

The electronic ballast 25 is connected to a 60 Hz AC power supply 26. The AC power supply 26 supplies alternating current at 60 Hz with a fixed voltage to the electronic ballast 25.

The electronic ballast 25 includes a filtering circuit 27, a power conditioning circuit (a step-down chopper) 28, a full-bridge circuit (a full-bridge inverter) 29, an igniter 30, and a dimming control circuit 31.

The filtering circuit 27 is for controlling power-factor and preventing electromagnetic wave interference, and connected to the AC power supply 26. The filtering circuit 27 receives electric power from the AC power supply 26, sustains a simple harmonic current having the same phase as a line voltage, and synchronously converts the line voltage having alternating polarity to a voltage having fixed polarity. At this time, the filtering circuit 27 steps up the line voltage to a voltage larger than a peak line voltage if needed. Also, the filtering circuit 27 limits the electromagnetic emission during the conversion.

The power conditioning circuit 28 receives the simple harmonic current and the voltage having fixed polarity from the filtering circuit 27, and generates and outputs a voltage and a current having fixed polarity, which are conditioned by the dimming control circuit 31 connected to the power conditioning circuit 28. The power conditioning circuit 28 also outputs 100% voltage at the start-up of the metal halide lamp 1, and performs an arc discharge.

The full-bridge circuit 29 converts the waveform of the fixed voltage outputted by the power conditioning circuit 28 into a low-frequency square wave.

The igniter 30 generates a starting voltage pulse of 4 kV, for instance. After that, the igniter 30 supplies the low-frequency square wave outputted by the full-bridge circuit 29 to the metal halide lamp 1, and lights up the metal halide lamp 1.

The dimming control circuit 31 conditions the received voltage to be a predetermined voltage according to a reference value which the dimming control circuit 31 internally has.

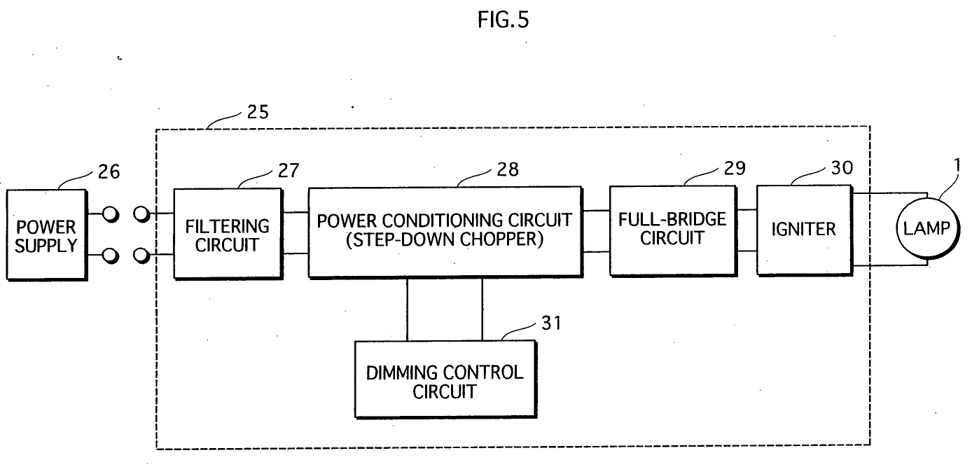

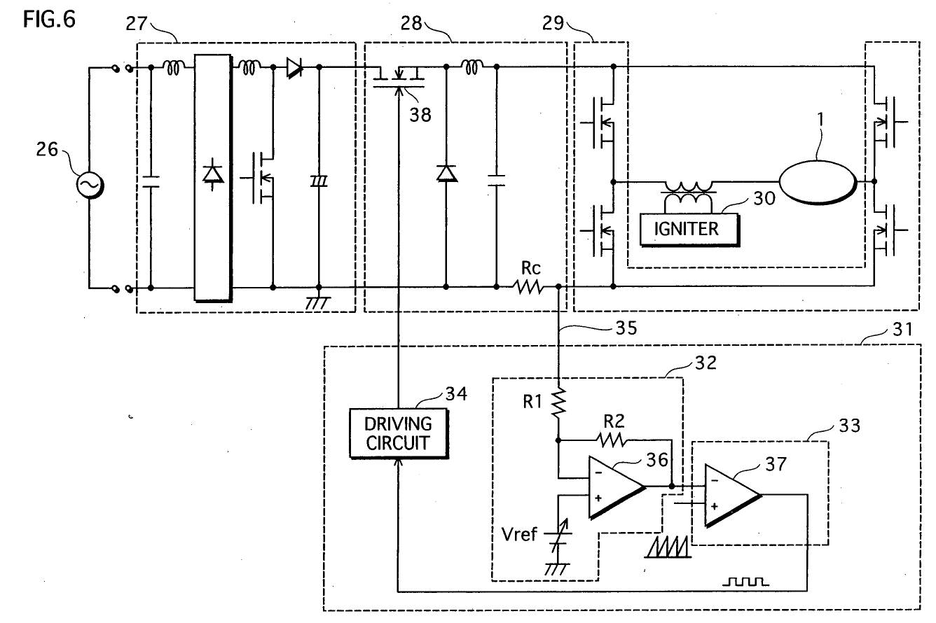

A circuit diagram of the electronic ballast 25 is shown in FIG. 6.

The filtering circuit 27 and the full-bridge circuit 29 is the same as the conventional technique, and therefore their descriptions are omitted here.

The power conditioning circuit 28 includes a resistance R_{c} for detecting the current passing through the metal halide lamp 1.

The dimming control circuit 31 includes an amplifier 32, a comparison unit 33, and a driving circuit 34. The dimming control circuit 31 monitors a current passing through the resistance R_{c} and converts the detected current to a voltage. (This voltage converted from the current is hereinafter called a “feedback signal 35”.)

The amplifier 32 includes a resistance R₁, a resistance R₂, and an error amplifier 36, and stores a reference voltage V_{ref}. The feedback signal 35 is inputted into the error amplifier 36 via the resistance R₁. The error amplifier 36 amplifies the feedback signal 35 based on the reference voltage V_{ref} and the resistances R₁ and R₂. By changing the reference voltage V_{ref}, the value of the current passing through the metal halide lamp 1 is set to a desired value. This changes the lamp output and realizes the dimming control.

The comparison unit 33 includes a comparer 37. The amplified feedback signal 35 is inputted to the comparer 37. Then, the comparer 37 compares the feedback signal 35 to a sawtooth wave, and generates a switching pulse signal for switching a switch 38 of the power conditioning circuit 28.

The driving circuit 34 conditions the level of switching pulse signal to be at a predetermined voltage level, and outputs the conditioned switching pulse signal to the switch 38. The ON/OFF of the power conditioning circuit 28 is controlled by the switching pulse, and a current at a desired level is supplied to the metal halide lamp 1.

Next, the inventors measured the change of the color temperature and the fluctuation rate of the lamp voltage after lighting up the lighting apparatus pertaining to the third embodiment of the present invention (hereinafter called the “practical example 12∞) for 6000 hours without dimming control, and successively changes the input lamp wattage down to 25% (38 W) of the rated lamp wattage. The following is the result.

Note that “the change of the color temperature” means the change of the color temperature during the early stage of the lighting (until when approximately 100 hours passed from the start of the lighting).

Also note that “the fluctuation rate of the lamp voltage” means the ratio of the lamp voltage at a time when the dimming control is performed to the lamp voltage at a time when the input lamp wattage is 100% of the rated lamp wattage.

The number of samples is five.

As to practical example 12, the inventors successively changed the input lamp wattage down to 25% (38 W) of the rated lamp wattage. However, the change of the color temperature was not more than 300K in every sample, and the change was almost not recognizable with eyes. Also, the fluctuation rate is only 5% to 10%.

However, when the input lamp wattage is less than 25% of the rated lamp wattage, the arc waved and flicker occurred in every sample. Further, when the lamp is lit up for a while after the dimming control is performed, the lighting failure occurred in one sample out of five. This is because the re-striking potential becomes too large to sustain the discharge. Therefore, it is preferable that the dimming control is performed with lamp wattage not less than 25% of the rated lamp wattage for preventing the lighting failure.

With the above-described structure of the lighting apparatus pertaining to the third embodiment of the present invention, which uses the metal halide lamp 1 pertaining to the first embodiment of the present invention, the lighting apparatus realizes high luminous efficiency, and at the same time, prevents the lighting failure of the metal halide lamp 1 caused by the rise in the lamp voltage. Also, the piece-to-piece variation in the lamp voltage can be decreased. Further, the lighting apparatus is capable of decreasing the amount of the mercury as the enclosure, and reducing an environmental burden. In addition, especially when the dimming control is performed by changing the input lamp wattage in a range from 25% to 100% of the rated lamp wattage, the lighting apparatus is capable of suppressing the fluctuation of the lamp voltage caused by the change of the input lamp voltage, and suppressing the change of color temperature.

It is preferable that the metal halide lamp 1 is lit up with a current having substantially square wave. This reduces the fluctuation of lamp wattage corresponding to the fluctuation of lamp voltage and stabilizes the temperature of the arc tube 6, and at the same time, realizes evenness of the temperature distribution on the arc tube 6. As a result, the lamp can stabilize the vapor pressure of the enclosure in the arc tube 6, and suppress the rise in the lamp voltage.

For surely preventing the fluctuation of the lamp voltage and the change of the color temperature during the dimming control, it is preferable that a relational expression 0.004<H_{hg}/Hₜ<0.22 is satisfied, where H_{hg} (mol) is the amount of halogen included in a mercury halide, such as mercuric iodide, and Hₜ (mol) is the total amount of metal included in enclosed metal halide except a mercury halide, such as praseodymium iodide and sodium iodide.

In the above-described third embodiment, a device shown in FIG. 5 and FIG. 6 is used as an electronic ballast. However, when other publicly known electronic ballast can realize the same effect.

In each embodiment described above, a metal halide lamp having the rated lamp wattage of 150 W is taken as an example. However, not only such a lamp but also other metal halide lamps having the rated lamp wattage in a range from 20 W to 400 W can realize the same effect.

Generally, a lamp having high rated lamp wattage tends to realize low power loss and high luminous efficiency. On the other hand, a lamp having low rated lamp wattage, for instance 150 W, tends to suffer high power loss and low luminous efficiency. Therefore, the effectiveness varies depending on the value of the rated lamp wattage. However, the present invention can improve the luminous efficiency relatively to the luminous efficiency of the conventional lamp having the same rated lamp wattage.

In each embodiment described above, only praseodymium iodide or only cerium iodide is enclosed as a lanthanide halide. However, in a case where other lanthanide halide, such as lanthanum (La) halide and neodymium (Nd) halide, is enclosed in addition to the praseodymium iodide or cerium iodide as well as a case where both praseodymium iodide and cerium iodide are enclosed, the same effect can be gained.

In each embodiment described above, sodium iodide, and mercuric iodide or mercurous iodide, and at least one lanthanide halide of praseodymium iodide and cerium iodide are enclosed. However, other publicly known metal halide may be enclosed according to a desired color temperature and color rendering.

In each embodiment described above, metal iodide is taken as an example metal halide. However, other metal halides, such as metal bromide can realize the same effect.

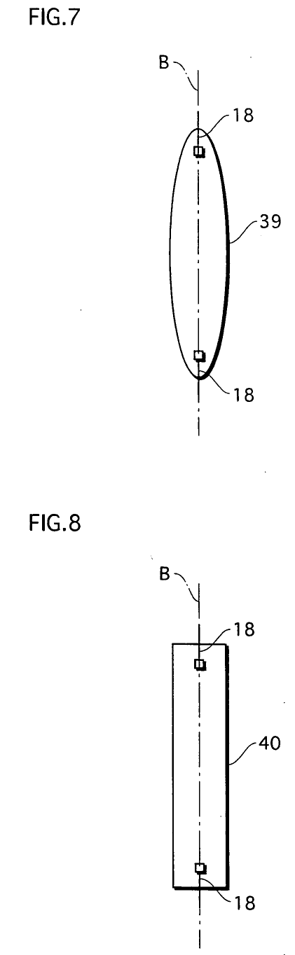

Further, in each embodiment described above, the arc tube 6, which has a shape shown in FIG. 1 and FIG. 2, is explained. However, arc tubes 39, 40, 41, 42, 43, and 44 respectively having shapes shown in FIG. 7 to FIG. 12 may be used. Note that the arc tubes 39 to 44 are bodies of revolution, each having a rotation axis (shown as B in each figure) in the longitudinal direction of the arc tube. The thickness of each arc tube is not considered here. The shapes of internal and external surfaces of the arc tubes 39 to 44 are as shown in the figures. A thin-tube part may be formed if needed in each of the arc tubes 39 to 44 shown in figures.

As to the arc tube 39 shown in FIG. 7, the out line of the cross section of the arc tube 39, which is cut along a plane including the rotation axis in longitudinal direction of the arc tube 39, is in a shape of an ellipse. This type of arc tube 39 has a simple structure, and therefore it can reduce the production cost. Also, a piece-to-piece variation in the color temperature can be reduced in a case of mass production. Therefore, when a plurality of lamps or lighting apparatuses respectively including such arc tubes are used in the same space for ceiling lighting, for instance, the piece-to-piece variation in the color temperature is not noticeable.

As to the arc tube 40 shown in FIG. 8, the out line of the cross section of the arc tube 40, which is cut along a plane including the rotation axis in longitudinal direction of the arc tube 40, is in a shape of a rectangle. This particularly reduces the change of the color temperature.

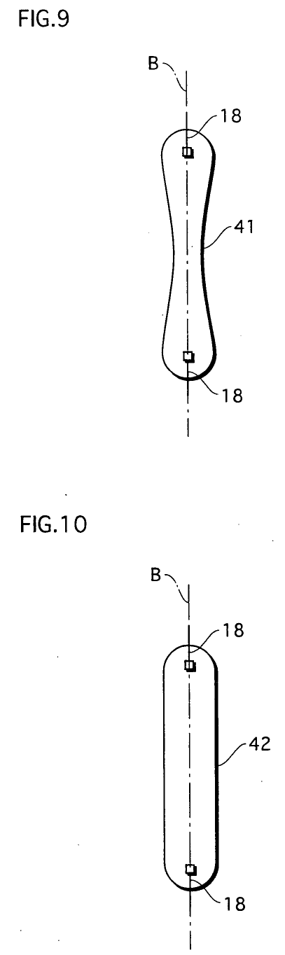

As to the arc tube 41 shown in FIG. 9, the cross section of the out line of the arc tube 41, which is cut along a plane including the rotation axis in longitudinal direction of the arc tube 41, is in a shape of a semicircle at both end portions, and the part connecting those semicircles is in a bow shape, having a depression. This arc tube 41 can quicken the initial rise of the light at a time of starting up. Although depending on its design, this arc tube 41 can shorten the time required to gain the rated light output by 10% to 20% as well. Also, its arc curvature is extremely gentle when it is horizontally disposed and lit up. This suppresses the flicker which occurs during the lighting.

As to the arc tube 42 shown in FIG. 10, the out line of the cross section of the arc tube 40, which is cut along a plane including the rotation axis in longitudinal direction of the arc tube 41, is in a shape of a semicircle at both end portions, and the part connecting those semicircles is in a shape of a straight line. This arc tube reduces the change of the color temperature above all.

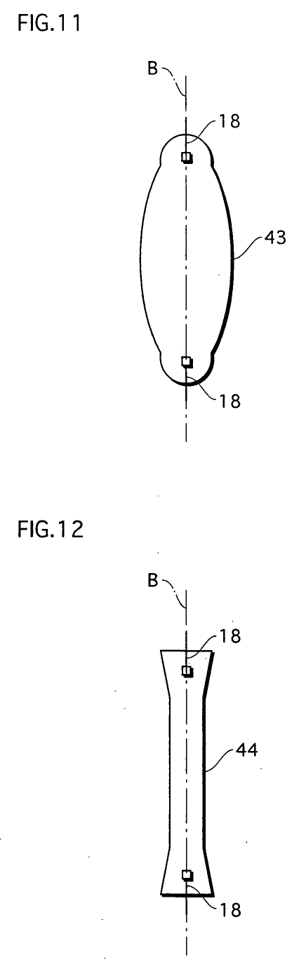

As to the arc tube 43 shown in FIG. 11, the out line of the cross section of the arc tube 43, which is cut along a plane including the rotation axis in longitudinal direction of the arc tube 43, is in a shape of a semicircle at both end portions, and the part connecting those semicircles is in a bow shape, having a projection. In the same way as the arc tube 39 described above, the arc tube 43 can suppress the piece-to-piece variation in the color temperature in a case of mass production. Therefore, when a plurality of lamps or lighting apparatuses respectively including such arc tubes are used in the same space for ceiling lighting, for instance, the piece-to-piece variation in the color temperature is not noticeable.

As to the arc tube 44 shown in FIG. 12, the out line of the cross section of the arc tube 44, which is cut along a plane including the rotation axis in longitudinal direction of the arc tube 44, is in a shape of a trapezoid at both end portions, and the part connecting those trapezoids is in a shape of straight line. In the same way as the arc tube 41 described above, the arc tube 44 can quicken the initial rise of the light at a time of starting up. Although depending on its design, this arc tube 44 can shorten the time required to gain the rated light output by 10% to 20% as well. Also, its arc curvature is extremely gentle when it is horizontally disposed and lit up, which suppresses the flicker during the lighting.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A metal halide lamp, comprising
an arc tube having an envelope made of translucent ceramic and a pair of electrodes disposed in the envelope, wherein
a sodium (Na) halide, a mercury (Hg) halide, and one or more lanthanide halides are enclosed within the arc tube, the lanthanide halides including at least one of a cerium (Ce) halide and a praseodymium (Pr) halide, and
L/D≧1, where D (mm) is an inside diameter of the arc tube, and L (mm) is a distance between the electrodes.

2. The metal halide lamp of claim 1, wherein
0.05≦H_{hg}/Hₗₙ≦2.00, where H_{hg} (mol) is an amount of a halogen included in the mercury halide, and Hₗₙ (mol) is an amount of a halogen included in the lanthanide halides.

3. The metal halide lamp of claim 1, wherein
the mercury halide is a mercurous halide.

4. The metal halide lamp of claim 2, wherein
the mercury halide is a mercurous halide.

5. The metal halide lamp of claim 1, wherein 4≦L/D≦10.

6. The metal halide lamp of claim 4, wherein 4≦L/D≦10.

7. The metal halide lamp of claim 1, wherein
a bulb wall loading is in a range of 28 W/cm² to 33 W/cm².

8. The metal halide lamp of claim 6, wherein
a bulb wall loading is in a range of 28 W/cm² to 33 W/cm².

9. The metal halide lamp of claim 1, further comprising
a bulb made of hard glass surrounding the arc tube, wherein
a pressure in a space between the bulb and the arc tube is equal to or less than 5×10⁴ Pa at 300K.

10. The metal halide lamp of claim 8, further comprising
a bulb made of hard glass surrounding the arc tube, wherein
a pressure in a space between the bulb and the arc tube is equal to or less than 5×10⁴ Pa at 300K.

11. A lighting apparatus, comprising:
the metal halide lamp of claim 1; and
an electronic ballast operable to light the metal halide lamp.

12. A lighting apparatus, comprising:
the metal halide lamp of claim 10; and
an electronic ballast operable to light the metal halide lamp.

13. A lighting apparatus, comprising:
the metal halide lamp of claim 1; and
an electronic ballast operable to perform a dimming control of the metal halide lamp in a range from 25% to 100% of a rated lamp wattage.

14. A lighting apparatus, comprising:
the metal halide lamp of claim 10; and
an electronic ballast operable to perform a dimming control of the metal halide lamp in a range from 25% to 100% of a rated lamp wattage.

15. The lighting apparatus of claim 13, wherein
0.004<H_{hg}/Hₜ<0.220, where H_{hg} (mol) is an amount of a halogen included in the mercury halide, and Hₜ (mol) is a total amount of metal included in all the metal halides enclosed within the arc tube except the mercury halide.

16. The lighting apparatus of claim 14, wherein
0.004<H_{hg}/Hₜ<0.220, where H_{hg} (mol) is an amount of a halogen included in the mercury halide, and Hₜ (mol) is a total amount of metal included in all the metal halides enclosed within the arc tube except the mercury halide.

17. The lighting apparatus of claim 14, wherein
the metal halide lamp is lit with use of a rectangular-wave current.

18. The lighting apparatus of claim 16, wherein
the metal halide lamp is lit with use of a rectangular-wave current.
